(19) United States
(12) Patent Application Publication
(10) Pub. No.: US 2008/0262821 A1
(43) Pub. Date: Oct. 23, 2008

(54) METHOD, APPARATUS, AND COMPUTER PROGRAM PRODUCT FOR DYNAMICALLY MANAGING SIMULATED ADDRESSES

(75) Inventors: Christopher T. Phan, Rochester, MN (US); Sharon D. Vincent, Rochester, MN (US)

Correspondence Address: CANTOR COLBURN LLP - IBM ROCHESTER DIVISION, 20 Church Street, 22nd Floor, Hartford, CT, 06103, US

(73) Assignee: INTERNATIONAL BUSINESS MACHINES CORPORATION, Armonk, NY (US)

(21) Appl. No.: 11/737,297

(22) Filed: Apr. 19, 2007

(51) Int. Cl. G06F 9/44

(52) U.S. Cl. 703/21

(57) ABSTRACT

A method, apparatus, and computer program product are provided for dynamically generating and managing addresses in a simulation environment. Address parameters and requests for addresses for performing commands from multiple simulation components are received. The multiple simulation components are associated with address maps. The requests include configuration parameters. Addresses are provided for performing the commands at the multiple simulation components based on the address parameters and the configuration parameters. Address generation is centrally managed such that when an address map for one simulation component changes, address maps associated with other simulation components and access to the other simulation components are not affected.

### BACKGROUND

The present invention relates generally to simulation, and, more particularly, to managing addresses in a simulation environment.

When a new chip design is developed, combinations of new or relatively unproven components may be used. To ensure that the components work together properly, a software-implemented design simulation process is often used. In a simulation environment, stimuli are provided to simulation models that interface with devices under test. The simulation models may include programmable representations of various hardware components. These programmable representations are commonly referred to as bus functional models (BFMs). By simulating components using BFMs, problems with a design can be identified before the physical chip is developed.

With the very large scale and complexity of chip designs today, the chip simulation environment can dramatically increase in size and complexity. This increase in size and complexity can be attributed to the requirement for these environments to model complex simulation scenarios in which specific simulation address sequences are generated to create cache line conflicts, target specific devices or buses or stress specific resources in the hardware. For example, in a simulation of a large multiprocessor environment, there will be a large number of simulation addresses to be generated and managed. In addition, interleaved and contiguous address regions need to be modeled and mapped to specific components and resources in the environment. Also, intelligent use of address constraints are needed to emulate the specific conflict and stress scenarios described above.

There are various problems associated with dynamically controlling and managing simulation addresses within a simulation environment. One problem is enabling the simulation environment to provide efficient real time generation and tracking of random addresses utilized during simulation and ensure that the generation of addresses follows the constraints of input biasing parameters to enable specific simulation scenarios to be generated and specific resources to be targeted.

One approach used in the past for solving this problem is to create a number of static addresses and their associated commands ahead of time and use triggering mechanisms to create the desired simulation scenarios. This approach is illustrated in FIG. 1, which shows a simulation environment using a Processor BFM 120 and an I/O BFM 130. One BFM function is to generate read and write transactions that are addressed within a particular bus address range in response to commands. Read and write transactions within the address range may be further constrained by configuration parameters. As shown in FIG. 1, manually generated parameters from a source 105a and parameters generated via script or an external tool 105b are delivered to a simulated parameter file 110. Manually generated commands and their associated addresses are delivered from source 105a to a simulated static test case file 115, along with commands and associated addressees generated via script/external tool 105b. The configuration parameters are driven from the parameter file 110 to state machines 140 and 160 in the processor BFM 120 and the I/O BFM 130, respectively. Commands and the associated addresses are driven from the static test case file 115 to the test case port 150 in the Processor BFM 120 for simulating performance of a processor and to the test case port 170 in the I/O BFM 130 for simulating performance of one or more I/O peripheral devices. These commands may be text files and may specify, e.g., patterns, how long a test should run, the type of command to execute (e.g., read/write etc.), the specific attributes of the command, such as the size, address, data etc., as well as synchronization information including how long a BFM should wait prior to processing another command or whether the BFM should execute a given set of commands completely prior to proceeding to the next command. The test case ports 150 and 170 pass the commands on to the state machines 140 and 160, respectively to constrain the operation of the state machines, e.g., informing the state machines what to write, the command to be executed, and the specific attributes of the command including command type, size, address, data, etc. The state machines 140 and 160, in turn, interface with devices under test (not shown). With the commands thus generated and delivered to the BFMs, simulation of performance of the model can be performed. FIG. 2 illustrates an example of a complete chain of an I/O DMA read command sequence in a conventional static test case/simulation file.

Drawbacks of this approach are the inefficiency and impracticality of keeping a large number of static addresses with their associated commands in simulation files (static test case files) and ensuring these files are updated and maintained as address definitions change. In addition, the number of these files increases dramatically as the defined testing scenarios increase.

Another problem is enabling the simulation environment to coordinate the random address generation of multiple components in the simulation environment to ensure simultaneous targeting of specific target addresses, buses or resources in the hardware to simulate conflict scenarios (i.e., multiple components simultaneously accessing the same target address or resource). Previous attempts to solve this problem included address generation capability distributed within the simulation environment among multiple components. Each component generated addresses according to input parameters, irrespective of the other components in the environment. This solution has the disadvantage of requiring manual or external tool manipulation of multiple sets of input parameters (one set of parameters for each component in the system) to simulate simultaneous conflict scenarios. The manual or external tool also generates static test case commands that must be stored in test case files as illustrated in FIG. 1.

Yet another problem is enabling the simulation environment to support “hot-plug” scenarios, including real time allocation of specific address regions to specific simulation components as devices are removed and added during simulation, without quiescing the entire system. This problem was also previously solved using static test case files. These test case files included synchronization commands used to quiesce all bus activity before a hot plug operation could be performed. Another synchronization command was then inserted after the hot plug command to ensure its successful completion before subsequent normal bus operations could follow. A downside of this approach is the static nature of the test cases and the maintainability issue as requirements change. In addition, there is no method that allows dynamic random insertion of hot plug commands and reconfiguration of the associated devices within the random simulation environment. Another disadvantage is the inability to perform hot-plug commands without quiescing the entire system.

There is thus a need for improving management of simulation addresses used by simulation components in a simulation environment such that simulation components can be plugged in and unplugged without interrupting simulation being performed by other simulation components.

### SUMMARY

The foregoing discussed drawbacks and deficiencies and others are overcome or alleviated by a method, an apparatus, and computer program product for dynamically generating and managing addresses in a simulation environment.

According to one embodiment, a method for dynamically generating and managing addresses in a simulation environment includes receiving address parameters and requests for addresses for performing commands from multiple simulation components having associated address maps. The requests include configuration parameters. The method further comprises providing addresses for performing the commands at the multiple simulation components based on the address parameters and the configuration parameters and centrally managing address generation such that when an address map associated with one simulation component changes, address maps associated with other simulation components and access to the other simulation components are not affected.

According to another embodiment, an apparatus for dynamically generating and managing addresses in a simulation environment includes an address generator module for receiving address parameters, a configuration module for receiving requests for addresses for performing commands from multiple simulation components having associated address maps. The requests include configuration parameters. The apparatus further includes a registration routines module for enabling simulation components to register the associated address maps, and a utility module for providing addresses for performing the commands at the multiple simulation components based on the address parameters and the configuration parameters. The address generator module, configuration module and utility module communicate with each other to centrally manage address generation, such that when an address map associated with one simulation component changes, address maps associated with other simulation components and access to the other simulation components are not affected.

According to another embodiment, a computer program product dynamically generates and manages addresses in a simulation environment. The computer program product includes a computer usable medium having a computer readable program. The computer readable program, when executed on a computer, causes the computer to receive address parameters and receive requests for addresses for performing commands from multiple simulation components having associated address maps. The requests include configuration parameters. The computer readable program further causes the computer to provide addresses for performing the commands at the multiple simulation components based on the address parameters and the configuration parameters and centrally manage address generation such that when an address map associated with one simulation component changes, address maps associated with other simulation components and access to the other simulation components are not affected.

### BRIEF DESCRIPTION OF THE DRAWINGS

Referring to the exemplary drawings wherein like elements are numbered alike in the several Figures:

FIG. 1 illustrates a conventional system for driving stimulus/command instructions into bus functional models;

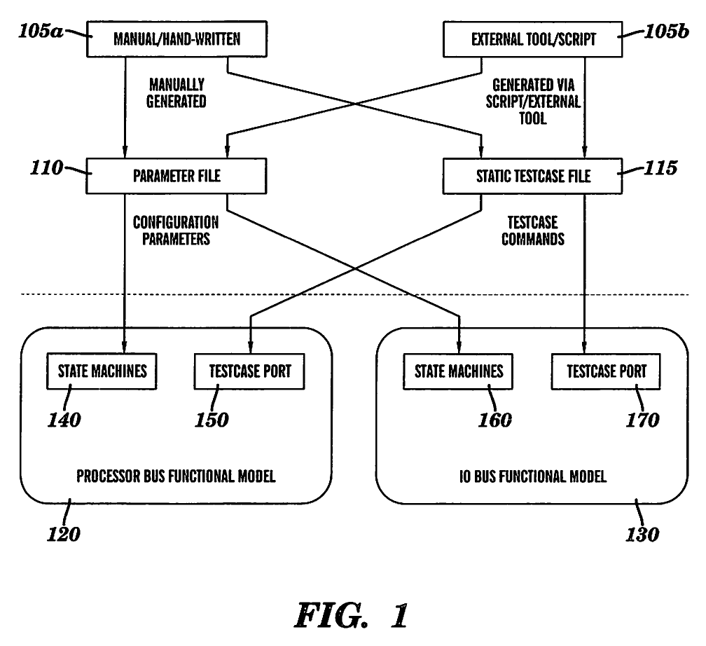

FIG. 2 illustrates an example of a complete chain of I/O DMA read command sequence in a static test case/simulation file;

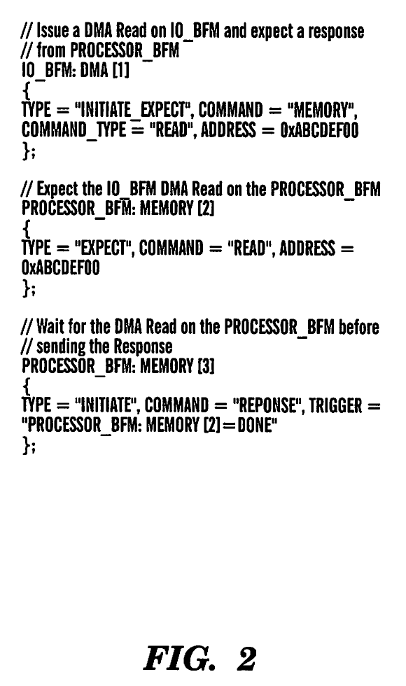

FIG. 3 illustrates an exemplary system for generating stimulus/command instructions by bus functional models with constraints from an address manager and a parameter file according to an exemplary embodiment;

FIG. 4 illustrates an example of a cycle simulation environment;

FIG. 5 illustrates exemplary address manager architecture;

FIG. 6 illustrates an exemplary system for configuring an address manager;

FIG. 7 illustrates an exemplary system for registering a simulation component with an address manager;

FIG. 8 illustrates an exemplary address conflict mechanism; and

FIG. 9 illustrates exemplary cycle simulation stages;

### DETAILED DESCRIPTION

According to exemplary embodiments, a method and apparatus are provided for a central addressing resource that is used to provide overall dynamic control, management, generation and tracking of simulation addresses within a simulation environment.

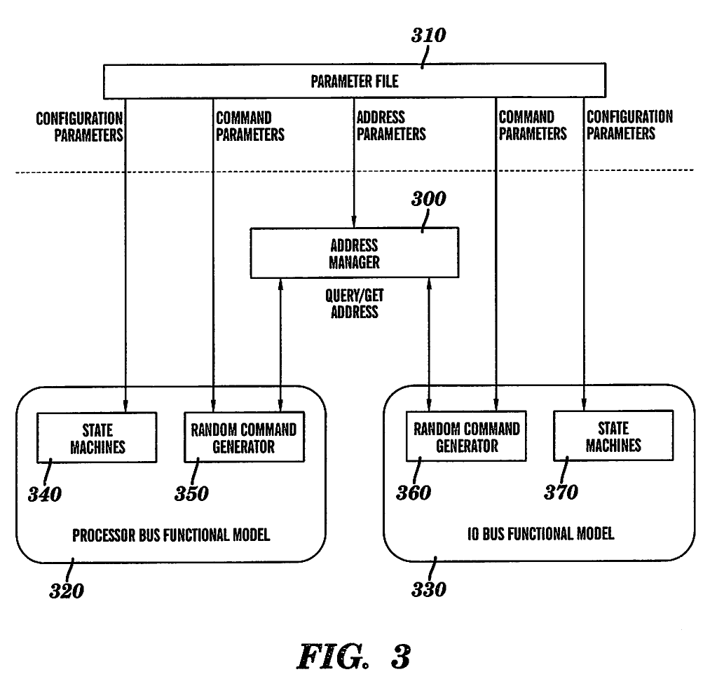

FIG. 3 illustrates an exemplary system for generating stimulus/command instructions using bus functional models with constraints from an address manager 300 and a parameter file 310. In FIG. 3, the dynamic simulation address manager 300 functions as a central addressing resource and is used to provide overall real time control, management, generation and tracking of simulation addresses within the simulation environment. The address manager 300 receives address parameters from the parameter file 310 and communicates with random command generators 350 and 360 in the Processor BFM 320 and the I/O BFM 330, respectively. Configuration parameters and command parameters are delivered directly from the parameter file 310 to state machines 340, 370 and random command generators 350, 360, respectively. The random command generators 350 and 360 communicate with the address manager 300 to get addresses to perform commands, e.g., read and write commands to memory. Once the random command generators 350 and 360 have obtained addresses from the address manager 300, these addresses are passed on to the state machines 340 and 370, respectively. The state machines, in turn, interface with the devices under test (not shown).

According to an exemplary embodiment, the address manager 300 maintains complete visibility to all memory (e.g., devices under test) within a simulation environment and how it maps to the various resources and devices within the environment. Using this information, the address manager 300 is able to intelligently manage, check and generate all addresses used by various simulation components in the simulation environment. In its address generation role, the dynamic address manager 300 is able to generate addresses according to input constraints (configuration parameters) to target specific resources in the environment and to simulate any testing scenario. By dynamically generating and monitoring these simulation addresses as needed based on constraint biases, the address manager 300 provides a central address resource that can be used by all components in the environment to determine the types of commands and target addresses that will be initiated during simulation. Thus, it eliminates the need for lengthy static address simulation files. It also allows the entire simulation environment to automatically adapt to changes in the address map. For example, if a certain target device or resource is specifically requested by a simulation component or by a simulation file used by that component, and the address map changes, this dynamic address manager 300 is able to return an address to the requesting component those maps to the desired target device or resource using the new address map. Therefore, all other components in the system are immune to address map changes. Also, this approach still allows specific addresses to be specified in simulation files if desired but has the additional advantage in this situation of using a central resource to verify that these addresses map to a valid target device as the address map changes.

In addition, rather than distributing address generation across multiple components in the simulation environment and allowing each component to generate addresses according to separate input parameters irrespective of other components, the dynamic address manager 300 has the advantage of using only a single set of input address generation biases to control address generation for all components in the simulation environment. As shown in FIG. 3, the dynamic address manager 300 allows all components in the simulation environment to target specific resources simultaneously using this single set of address biasing parameters rather than having biasing parameters interspersed among simulation components and attempting to manually coordinate this biasing or implementing an external tool to coordinate the biasing between these components.

Furthermore, in hot-plug simulation scenarios, the dynamic address manager 300 provides registration routines (explained in detail below) that allow hot-plug-aware bus functional models to un-register and re-register their address regions with new address configurations. These new address configurations include interleave and contiguous memory regions supported by the BFMs. This registration or deregistration may be performed while the simulation is executing, and address mapping may be dynamically updated within the address manager. The address manager may then use the updated information in future address generation. This registration technique has advantages over the manual hot plug methods used in the past because this technique allows a new device to be dynamically integrated into the address map of the entire simulation system for hot plug insertion or dynamically removed from the address map for hot plug removal while simulation is executing. This eliminates the need to quiesce all activity in the simulation environment while executing a hot-plug command. It also eliminates the need to read in static simulation files or parameters to update the memory map for the simulation environment. This provides real time test scenarios and allows hot-plug operations to happen concurrently with normal bus activities.

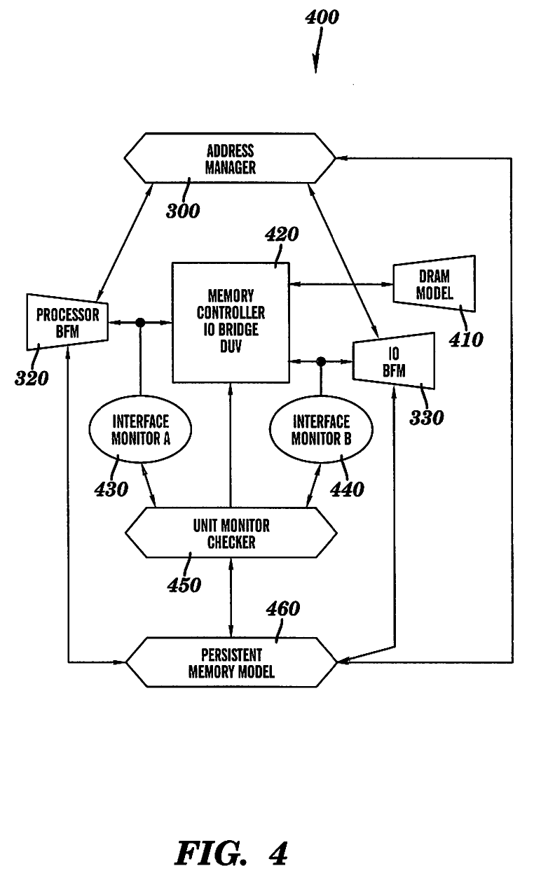

FIG. 4 illustrates the components of an exemplary cycle simulation environment 400. In a simulation environment 400, such as that shown in FIG. 4, simulation components may be modeled using one or more BFMs, one or more devices under verification (DUVs), etc. The simulation components operate to simulate data exchanges between components in a computer system. The BFMs model the behavior of a component whose operation is known, well defined, or otherwise considered reliable, and the DUV simulates components whose operation needs to be tested to ensure that it can operate reliably.

Referring to FIG. 4, the address manager 300 controls and maintains all addressable regions within the simulation environment 400 for simulating the performance of various components within the simulation environment. As shown in FIG. 4, the address manager 300 communicates with a processor BFM 320 to provide addresses for simulating operation of a processor. The address manager 300 also communicates with the I/O BFM 330, providing addresses for simulation of performance of I/O peripheral devices in a computer system. The BFM 320 and I/O BFM 330, in turn, communicate with the Memory controller I/O bridge Device Under Test (DUV) 420, using addresses generated by the address manager to perform operations on various memory regions and/or registers (e.g., read and write operations). Interface Monitor A 430 and Interface Monitor B 440 observe traffic between the Memory Controller Bridge I/O Bridge DUV 420 and the Processor BFM 320 and the I/O BFM 330, respectively. The Interface Monitors provide information on this traffic to the Unit Monitor Checker 450. The Unit Monitor Checker 450 uses this information to update the Persistent Memory Model 460 during write operations and to compare data on the interface with the Persistent Memory Model 460 during read operations. The Processor BFM 320 and/or the I/O BFM 330 may also interact with the Persistent Memory Model 460 if these BFMs have registered memory regions with the Address Manager 300. This interaction includes updating the Persistent Memory Model 460 when a write operation is received and retrieving data images from the Persistent Memory Model 460 when a read operation is received. The Unit Monitor Checker 450 is also able to view signals internal to the Memory Controller I/O Bridge DUV 420 which can be used by the Unit Monitor Checker 450 to correlate interface commands from one interface to those on another interface. The DRAM model 410 simulates operation of a DRAM and communicates with the Memory Controller I/O Bridge DUV 420 for memory accesses to memory regions that are local to the Memory Controller I/O Bridge DUV 420.

Table 1 lists exemplary addressable regions that can be controlled by the address manager 300. As simulation advances, the address manager 300 monitors address usage and generates new addresses as needed based on constraint bias parameters.

TABLE 1
Simulation Address Regions

| Address | | | |
|---|---|---|---|
| Region | Source | Destination | Length |
| Memory | Processor, | Memory | cache line |
| | IO | | |
| MMIO | Processor | IO | 1B - cache line |
| PIO | Processor | IO | 1B–4B |
| Interrupt | Processor, | Processor, | Operation |
| | IO | IO | Dependent |
| Configuration | Processor | IO | 1B–4B |

In this table, MMIO and PIO represent types of memory regions that are typically included in a Simulation environment. MMIO stands for Memory Mapped I/O, and PIO stands for I/O Port Address Space. Column 1 in this table provides an example of the types of memory regions that may be accessed in simulation environment. Columns 2 and 3 represent the possible Initiators of commands to these address regions and the possible Targets (Destinations) of these commands, respectively. Column 4 represents an example of some of the constraints (in terms of transfer sizes) that may be placed on commands directed to these memory regions. The information in this table is for exemplary purposes only. For any given simulation environment the number of regions and source/destination combinations as well as transfer sizes can vary widely.

According to exemplary embodiments, each of the components in the simulation environment 400 may be implemented with software run on, e.g., a personal computer. As an alternative, one or more of the components may be implemented with an Application Specific Integrated Chip (ASIC) using a hardware design language representation of the hardware, e.g., a VHDL or Verilog representation of the hardware, that has been compiled to a form that allows it to be simulated.

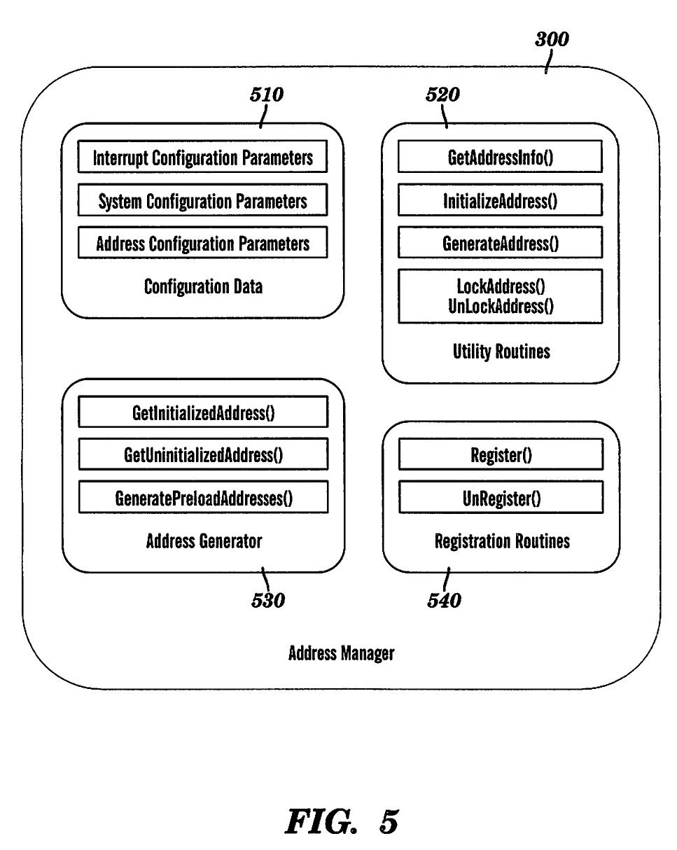

FIG. 5 illustrates the architecture of the address manager according to an exemplary embodiment. The address manager architecture 300 is divided into a configuration data module 510, a utility routines module 520, an address generator module 530, and a registration routines module 540. The configuration data module 510 contains the configuration information of the entire simulation environment and is used to constrain and bias the address generation process. The registration routines module 540 is used to register and un-register simulation components with the address manager 300. The utility routines module 520 can be accessed by other simulation components to obtain random addresses or to query information about a specific address. The address generator module 530 is responsible for address generation.

The configuration data module 510 includes interrupt configuration parameters, system configuration parameters, and address configuration parameters. The interrupt configuration parameters are used in conjunction with the address configuration parameters to govern the generation of addresses for interrupt address regions. The system configuration parameters are used in conjunction with the address configuration parameters to govern how addresses are generated for various system types and configurations. The address configuration parameters are used to constrain simulation address generation.

The registration routines module 540 includes Register( ) and UnRegister( ) routines. The Register( ) routine registers the simulation component with the address manager 300. The return value indicates whether the operation is a success or failure. For example, a “0” code return reports successful registration. A “1” code return signals an error. The UnRegister( ) routine un-registers the simulation component with the address manager 300. The return value indicates whether the operation is a success or failure. For example, a “0” code return reports successful registration. A “1” code return signals an error.

The utility routines module 520 includes a GetAddressInfo( ) routine, an InitializeAddress( ) routine, a GenerateAddress( ) routine, and a LockAddress( )/UnlockAddress( ) routine. The GetAddressInfo( ) routine returns information related to a specific address. The information includes the address region and information regarding the BFM or device associated with the address. The InitializeAddress( ) routine preloads appropriate memory and caches for the input address based on input biases and parameters. The GenerateAddress( ) routine randomizes and returns an address based on input biases and parameters. The LockAddress( )/UnlockAddress( ) routine locks or unlocks a simulation address. This can be used to keep an address from being used by other operations.

The address generator module 530 is responsible for generating and managing simulation addresses based on input biases and parameters. The address generator 530 includes a GetInitializedAddress( ) routine, a GetUninitializedAddress( ) routine, and a GeneratePreloadAddresses( ) routine. The GetInitializedAddress( ) routine returns an initialized address that was generated by GeneratePreloadAddresses( ) routine or that has already been initialized by a previous command. The GetUnInitializedAddress( ) routine returns an uninitialized address (e.g., one that was not preloaded or has not been initialized by a previous command) based on input biases and/or constraint parameters. The GeneratePreloadAddresses( ) routine randomizes a number of addresses based on constraint parameters and preloads these addresses to memory and caches, accordingly.

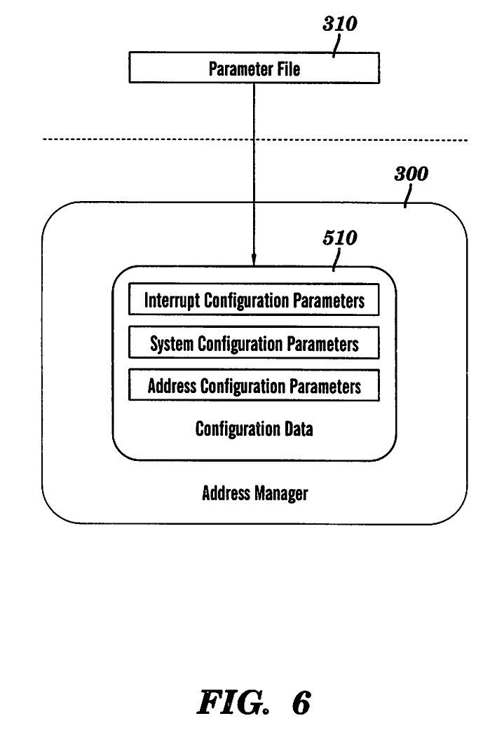

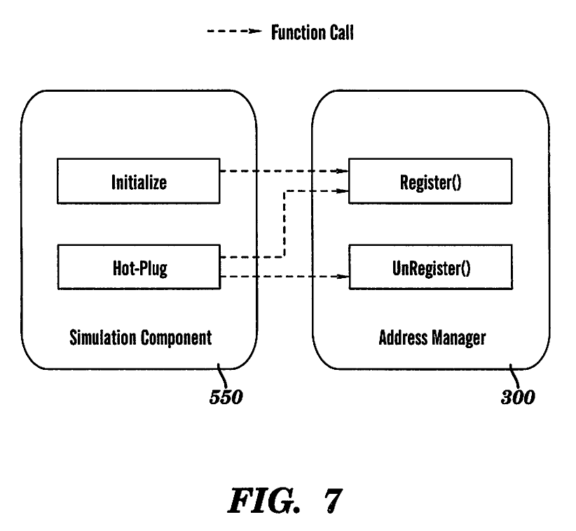

According to exemplary embodiments, address regions are assigned to simulation components, e.g., BFMs, through the registration functions (described in detail below with reference to FIG. 7). In addition, as illustrated by FIG. 6, input parameters are used by the configuration module 510 in the address manager 300 to bias and constrain the way simulation addresses are generated.

Referring to FIG. 7, during initialization, one or more simulation components 550 (which may include, e.g., one or more BFMs, etc.) dynamically register their address regions with the address manager 300. When a simulation component 550 is executing a hot-plug operation, it un-registers itself with the address manager 300 to have its address region released (simulating device removal). The simulation component 550 then re-registers with the address manager 300, providing its address region (simulating new device insertion). The “new” simulation component is then ready for operation.

For coherency protocol verification in multi-processor simulation environments, preloading and initializing coherent addresses to interesting states in all memory and caches is key to speeding up simulation and verifying hard-to-hit simulation scenarios. Cache line address reuse is needed to create interesting conflict scenarios where multiple coherent operations are repeatedly accessing the same cache line address.

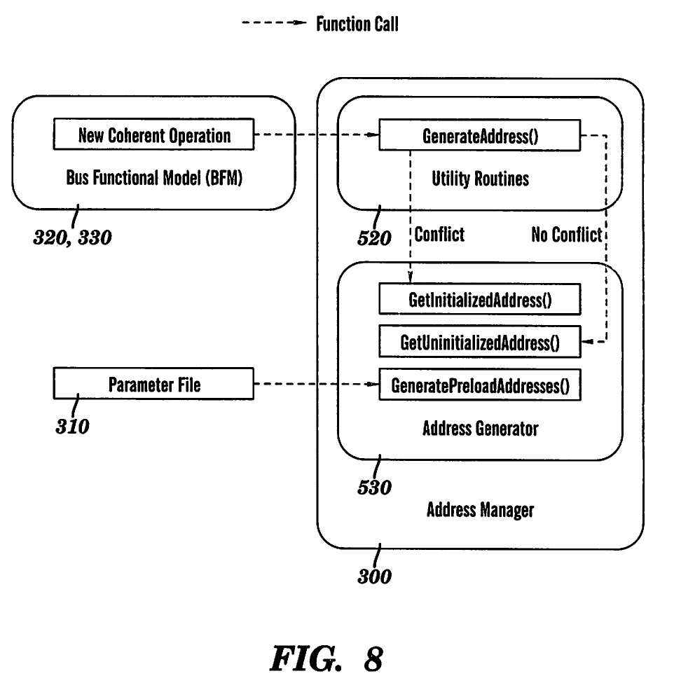

According to an exemplary embodiment, the address manager 300 supports an address conflict mechanism in which environment biases and parameters control the generating of coherent addresses and the preloading of these address locations in memory and cache components, accordingly. The address manager 300 then makes these preloaded addresses available for coherent operations that require conflicting or reused addresses. FIG. 8 illustrates an exemplary address conflict mechanism.

Referring to FIG. 8, when a BFM 320, 330 initiates a new coherent operation, it communicates with the utility routines module 520 in the address manager 300 to get simulation addresses. When a BFM 320, 330 communicates with the utility routines module 520 using GenerateAddress( ), it provides information in the GenerateAddress( ) input arguments as to whether an address conflict is desired. In other words, if an address conflict is indicated as being desired, this BFM 320, 330 is requesting an address that has already been used by this or another BFM 320, 330 or preloaded by the address manager 300 prior to this command. If an address conflict is not indicated as being desired, then this BFM 320, 330 is requesting an address that has not already been used or preloaded. If an address conflict is indicated as being desired, the utility routines module 520 communicates with the GetInitializedAddress( ) routine of the address generator module 530 to get initialized addresses. If no conflict is indicated as being desired, the GenerateAddress( ) routine of the utility routines module 520 communicates with the GetUnInitializedAddress( ) routine of the address generator 530. Constraints are loaded into the GeneratePreloadAddresses( ) routine from the parameter file 310.

According to exemplary embodiments, address regions and information may be dynamically registered and unregistered at run time, and a set of well-defined software interfaces may handle the data structures being passed between the simulation components and the address manager. Registration routines register new functionality and addressing capability offered by the simulation components that can be used by the address manager when generating addresses for that device. The arguments passed to the address manager registration functions may be pointers to data structure that describe the address region information of the simulation component. These data structures are versatile enough to describe both interleaved and contiguous address regions supported by the device being registered. As explained above, simulation components that can register with the address manager include BFMs, such as processor or I/O Peripheral Devices BFMs. The registration methods described herein have advantages over the manual hot plug testing methods because they allow a new device to be dynamically integrated into the address map of the entire system for hot plug insertion or dynamically removed from the address map for hot plug removal while simulation is executing. This eliminates the need to quiesce all activity in the simulation environment while executing a hot-plug command. It also eliminates the need to read in static simulation files or parameters to update the memory map for the simulation environment. This provides real time test scenarios and allows hot-plug operations to happen concurrently with normal bus activities.

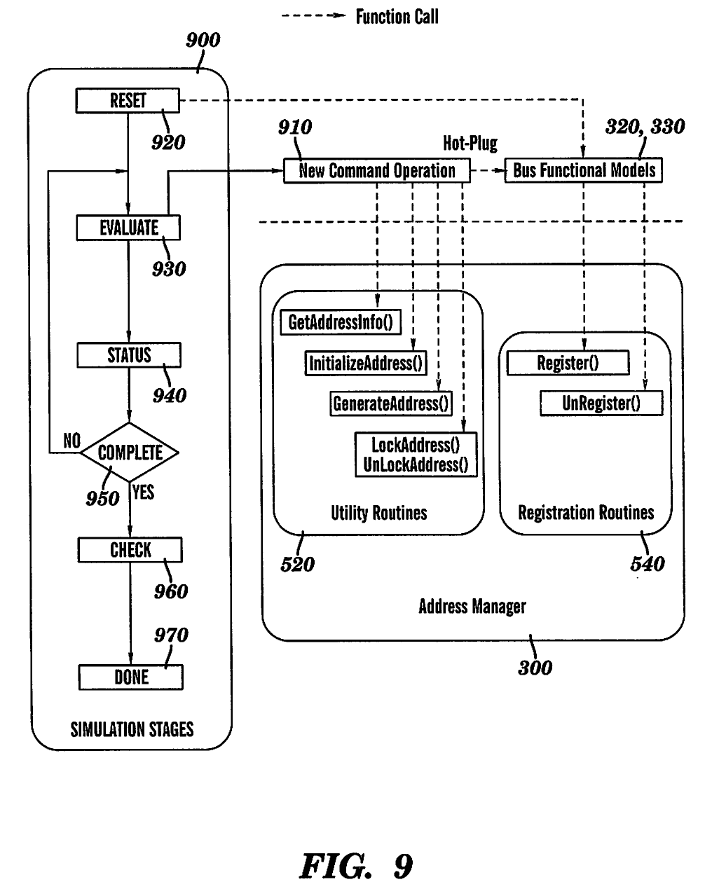

FIG. 9 illustrates various stages 900 included in an exemplary cycle simulation and also illustrates the software interfaces available to a device that is executing a new command operation 910 according to an exemplary embodiment. Referring to the simulation stages 900, variables are initialized at a reset stage 920, and a function call is made to the BFMs 320, 330. In an evaluate stage 930, commands are generated on the fly with the associated address manager or using test case commands. The new command operation 910 is communicated as a hot plug operation to the BFMs 320, 330 and the address manager 300, and the command is executed. In the status simulation stage 940, the current state of the various simulation components is evaluated (e.g. whether they are active or idle). Next, a determination is made whether the simulation is complete at stage 950. If so, a check is run to determine success or failure of the simulation at stage 960, and the cycle ends at stage 970. If the simulation is not successful or complete, the cycle returns to the evaluation stage 930.

While the invention has been described with reference to an exemplary embodiment or embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

What is claimed is:

1. A method for dynamically generating and managing addresses in a simulation environment, comprising:
receiving address parameters;
receiving requests for addresses for performing commands from multiple simulation components having associated address maps, the requests including configuration parameters;
providing addresses for performing the commands at the multiple simulation components based on the address parameters and the configuration parameters; and
centrally managing address generation such that when an address map associated with one simulation component changes, address maps associated with other simulation components and access to the other simulation components are not affected.

2. The method of claim 1, wherein the step of providing addresses includes determining whether specific addresses provided for use by simulation components map to valid address maps of simulation components.

3. The method of claim 1, further comprising:
registering a simulation component upon introduction into the simulation environment, including receiving and registering the address map associated with the simulation component.

4. The method of claim 3, wherein the step of registering is performed while simulation is being performed by at least one other simulation component.

5. The method of claim 3, further comprising:
unregistering a simulation component upon removal of the simulation component from the simulation environment, including releasing the registered address map associated with the simulation component.

6. The method of claim 5, wherein the step of unregistering is performed while simulation is being performed by at least one other simulation component.

7. The method of claim 1, further comprising generating conflicting addresses.

8. An apparatus for dynamically generating and managing addresses in a simulation environment, comprising:
an address generator module for receiving address parameters;
a configuration module for receiving requests for addresses for performing commands from multiple simulation components having associated address maps, the requests including configuration parameters; and
a utility module for generating random addresses and in some cases initializing and/or locking these addresses for performing the commands at the multiple simulation components based on the address parameters and the configuration parameters, wherein the address generator module, configuration module, and utility module communicate with each other to centrally manage address generation, such that when an address map associated with one simulation component changes, address maps associated with other simulation components and access to the other simulation components are not affected.

9. The apparatus of claim 8, wherein the utility module determines whether specific addresses provided for use by simulation components map to valid address maps of simulation components as part of providing addresses.

10. The apparatus of claim 8, further comprising:
a registration module for registering a simulation component upon introduction into the simulation environment, wherein the registration module receives and registers an address map associated with the simulation component upon introduction of the simulation component into the simulation environment.

11. The apparatus of claim 10, wherein the registration module performs registration while simulation is being performed by at least one other simulation component.

12. The apparatus of claim 10, wherein the registration module also unregisters a simulation component upon removal of the simulation component from the simulation environment, wherein the registration module releases the registered address map associated with the simulation component when the component is removed from the simulation environment.

13. The apparatus of claim 12, wherein the registration module performs unregistering while simulation is being performed by at least one other simulation component.

14. The apparatus of claim 8, wherein the utility routines module communicates with the address generator module to generate conflicting addresses.

15. A computer program product for dynamically generating and managing addresses in a simulation environment, comprising a computer usable medium having a computer readable program, wherein the computer readable program, when executed on a computer, causes the computer to:
receive address parameters;
receive requests for addresses for performing commands from multiple simulation components having associated address maps, the requests including configuration parameters;
provide addresses for performing the commands at the multiple simulation components based on the address parameters and the configuration parameters; and
centrally manage address generation such that when an address map associated with one simulation component changes, address maps associated with other simulation components and access to the other simulation components are not affected.

16. The computer program product of claim 15, wherein the computer readable program causes the computer to determine whether specific addresses provided for use by simulation components map to valid address maps of simulation components as part of providing addresses for performing the commands.

17. The computer program product of claim 15, wherein the computer readable program further causes the computer to:
register a simulation component upon introduction into the simulation environment, including receiving and registering an address map associated with the simulation component.

18. The computer program product of claim 17, wherein the computer readable program causes the computer to register simulation component while a simulation is being performed by at least one other simulation component.

19. The computer program product of claim 17, wherein the computer readable program further causes the computer to unregister a simulation component upon removal of the simulation component from the simulation environment, including releasing the registered address map associated with the simulation component when the component is removed from the simulation environment.

20. The computer program product of claim 19, wherein the computer readable program causes the computer to perform unregistering while a simulation is being performed by at least one other simulation component.
